(19) United States
(12) Patent Application Publication
(10) Pub. No.: US 2016/0342072 A1
(43) Pub. Date: Nov. 24, 2016

(54) INTEGRAL RANGE EXTENDER AND MECHANICAL PROTECTOR SYSTEM FOR A HANDHELD DIGITAL DEVICE

(71) Applicant: QT INTERNATIONAL LTD., Jerusalem (IL)

(72) Inventors: Yekutiel Sherman, Jerusalem (IL); Yachin Yarchi, Jerusalem (IL)

(73) Assignee: QT INTERNATIONAL LTD., JERUSALEM (IL)

(21) Appl. No.: 14/741,485

(22) Filed: Jun. 17, 2015

Related U.S. Application Data
(60) Provisional application No. 62/163,415, filed on May 19, 2015.

(51) Int. Cl. G03B 17/56

(52) U.S. Cl. CPC G03B 17/561

(57) ABSTRACT

Described herein is an integral range extender and mechanical protector system for a handheld digital device, which includes a chassis adapted for securing to the device; and a selectably-deployable dual purpose collapsible rod operable in a first, folded mode for storage across the rear of the device so as to cover a major portion of the area thereof thereby, together with said chassis, to absorb mechanical forces directed towards the sides or rear of the device. The system is further operable in a second mode for extension in a direction transverse from the chassis, whereby a first end is adapted to support the device and a second distal end is adapted to be held in the hand of a user, wherein, in said second mode, use of said collapsible rod permits positioning of the device from the user and use thereof remotely from the user.

### CROSS REFERENCE TO RELATED APPLICATIONS

Benefit is claimed to U.S. Provisional Patent Application No. 62/163,415, filed on May 19, 2015, which is incorporated by reference herein in its entirety.

### FIELD OF THE INVENTION

The present invention relates to assistive devices for mobile communications devices generally, particularly mobile phones having photographic capability.

### BACKGROUND OF THE INVENTION

Protective cases for mobile phones are well known. They typically include one or two layers of protective plastic/rubber and are fashioned to encase the rear and sides of the phone, thereby to prevent it from being damaged by being dropped or otherwise mechanically impacted. While such cases add bulk and cost to the phone, these factors are outweighed due to their use in preventing damage to an item which is relatively expensive and inconvenient to replace.

More recently, with the advent of high quality digital photography on mobile phones and the widespread internet connectivity of these devices, it has become commonplace for these devices to be used for self-photography, pictures being taken in this manner often then being shared with others or otherwise uploaded to social networking sites on the internet.

A disadvantage of self-photography by use of mobile phones is that the range at which one can hold the phone is limited by the length of the user's arm, such that the resulting picture loses much of the perspective that would normally be present in a convention picture taken by a third party (i.e. someone who is not in the picture).

Furthermore, there are many situations in which the person taking a photograph of scenery or wildlife, for example, would like to take a photograph from somewhat closer to the object being photograph, but is unable to do so as he is limited by the device being held literally at arm's length. This is particularly a problem when taking a photograph with a mobile phone, as conventional phone do not normally have an optical zoom capability, but a digital zoom. When the digital zoom is used, it increases the graininess of the resulting image, such that it is of poorer quality than desired.

In an effort to solve this problem, so-called ‘settle sticks’ have been developed. Essentially, they enable a user to hold a stick which, in turn, supports the mobile phone distally from the end being held by the user. This therefore extends the range of useful use by a distance equal to the length of the stick. Early range extender sticks, intended for use with photographic equipment which does not necessarily include mobile phones are described, at least in part, in US Patent Publications Nos. 2004/0223752 and 2007/0177866.

However, one of the well-known problems of selfie sticks is that they are bulky to carry around and thus inconvenient.

US Patent Publication No. 2007/0053680 discloses a telescopically extendible grip for a camera which represents an approach which could be useful in mitigating the bulkiness of selfie sticks, although the described ‘grip for a camera’ still represents an article which must be carried in addition to the camera in order to be used. Having such an additional item is an additional item to remember, or potentially forget and lose.

US Patent Publication No. US 2015/0029352 entitled Collapsible Cell Phone Boom Arm is directed to an extendible boom arm which is attached to a cell phone casing. In concept, this is similar to the ExtendaPic iPhone 5/5s Case, shown at http://www.extendapic.com/.

While both represent an improvement over previous solutions, as they are based on the use of a telescopic arm, the additional range that they can provide is, by definition, limited.

### SUMMARY OF THE INVENTION

There is provided an integral range extender and mechanical protector system for a handheld digital device, which includes a chassis adapted for securing to the device; and a selectably deployable dual purpose collapsible rod operable in a first, folded mode for storage across the rear of the device so as to cover a major portion of the area thereof thereby, together with the chassis, to absorb mechanical forces directed towards the sides or rear of the device, and further operable in a second mode for extension in a direction transverse from the chassis, whereby a first end is adapted to support the device and a second distal end is adapted to be held in the hand of a user, wherein, in the second mode, use of the collapsible rod permits positioning of the device from the user and use thereof remotely from the user.

Additionally, the system preferably also includes a dual purpose engagement member operative for engagement with the chassis so as to secure the collapsible rod thereto when in the first, folded mode and for supporting the chassis and device on the collapsible rod when in the second mode.

Further, the first end of the collapsible rod and the dual purpose engagement element are preferably configured for interlocking engagement so as to prevent relative rotation therebetween, thus also preventing rotation of the device about the collapsible rod when supported thereon.

Additionally, preferably the first end of the collapsible rod terminates in a male locking member and the dual purposed engagement member has a shaped opening formed therein adapted to receive the male locking member, and the male locking member has formed thereon a locking protrusion and the dual purpose engagement member has formed therein a notch communicating with the shaped opening, the notch being adapted to receive the locking protrusion therein in locking engagement, thereby to prevent relative rotation between the male locking member and the shaped opening.

Further, the collapsible rod is preferably formed of a plurality of self-assembly, mutually foldable rod elements configured for end-to-end assembly.

Additionally, the collapsible rod preferably also includes an elastic cord element extending through the plurality of self-assembly rod elements, operative, in the absence of forces preventing this, to coaxially align the rod elements and pull them together from a mutually folded arrangement into end-to-end mating connection.

Further, preferably each rod element has a first and second end, each first end being adapted for end-to-end engagement with the second end of an adjacent rod element, wherein the first and second ends of each rod element are configured for interlocking engagement so as to prevent relative rotation therebetween, thus also preventing rotation of the device about any portion of the collapsible rod when supported thereon.

Additionally, preferably the first end of each rod element terminates in an alternating sequence of teeth and notches surrounding an opening, and the second end of each rod element includes a male locking member having a limiting shoulder formed at a predetermined distance from the tip of the male member, the male member of a first rod element being adapted for insertion through the opening of a second rod element so as to become mutually engaged therewith, until a maximum depth whereat the limiting shoulder abuts the teeth, wherein the male locking member has formed thereon a locking protrusion which, when the male member is at the maximum depth, the locking protrusion is engaged by any one of the notches, thereby to prevent relative rotation between the first and second rod elements.

Further, the plurality of rod elements are preferably produced by a 3-D printing process, formed of PLA and/or ABS mixed with a multi-directional carbon fiber.

Additionally, the system preferably also includes a remotely located control for operating the digital device.

Further, the remotely located control is preferably mounted at the second, distal end of the collapsible rod.

Additionally, the chassis has a rear side and preferably has provided thereon either positioning elements for positioning the collapsible rod against the rear side when in the first, folded mode, or fastening elements for grasping and fastening the rod elements against the rear side when in the first, folded mode.

Further, at least the second end portion of the collapsible rod is preferably hollow, the system preferably also includes a backup battery housed therewithin.

### BRIEF DESCRIPTION OF THE DRAWINGS

The present invention will be more fully understood and appreciated from the following detailed description taken in conjunction with the drawings in which:

FIG. 1 is a rear isometric view of an integral range extender and mechanical protector system for a digital device, constructed in accordance with the present description, in a closed position;

FIG. 2 is a rear isometric view of the system of FIG. 1 but in a partially open position;

FIG. 3 is a front isometric view of the system of FIGS. 1 and 2, in a fully deployed position;

FIGS. 4A-4D show the system as seen in FIG. 1 when mounted onto a digital device, depicted from the rear, top, side and bottom, respectively;

FIG. 5 shows the system as seen in FIG. 2 when mounted onto a digital device;

FIG. 6A shows the complete system shown in FIGS. 1-5, in a first fully deployed position, when supporting a digital device therein;

FIG. 6B shows the mounting of the device-carrying chassis and dual purpose engagement member of the system with the dual purpose collapsible rod thereof, when in a fully extended position;

FIG. 6C shows an enlarged view of a portion of FIG. 6B;

FIG. 7A shows the complete system shown in FIGS. 1-5, in a second fully deployed position, when supporting a digital device therein;

FIG. 7B shows the mounting of the device-carrying chassis and dual purpose engagement member of the system with the dual purpose collapsible rod thereof, when in a fully extended position;

FIG. 7C shows an enlarged view of a portion of FIG. 7B;

FIG. 8A shows a single rod element connected to an adjoining rod element; and

FIG. 8B is an enlarged view of the connection in FIG. 8A, illustrating a preferred anti-rotation locking mechanism provided thereat;

FIGS. 9A and 9B is a block diagram illustration of basic interactive operational components of the integral range extender and mechanical protector system and a mobile communications device, wherein the digital device is operated via a wired connection and a wireless connection, respectively;

FIGS. 10A and 10B shows the rear side of the chassis as seen in FIGS. 7A and &7B, but having clips provided thereon for fastening the collapsible rod thereto; and

FIG. 11 is a schematic illustration of a handle portion of the collapsible rod, housing therein a backup battery.

### DETAILED DESCRIPTION

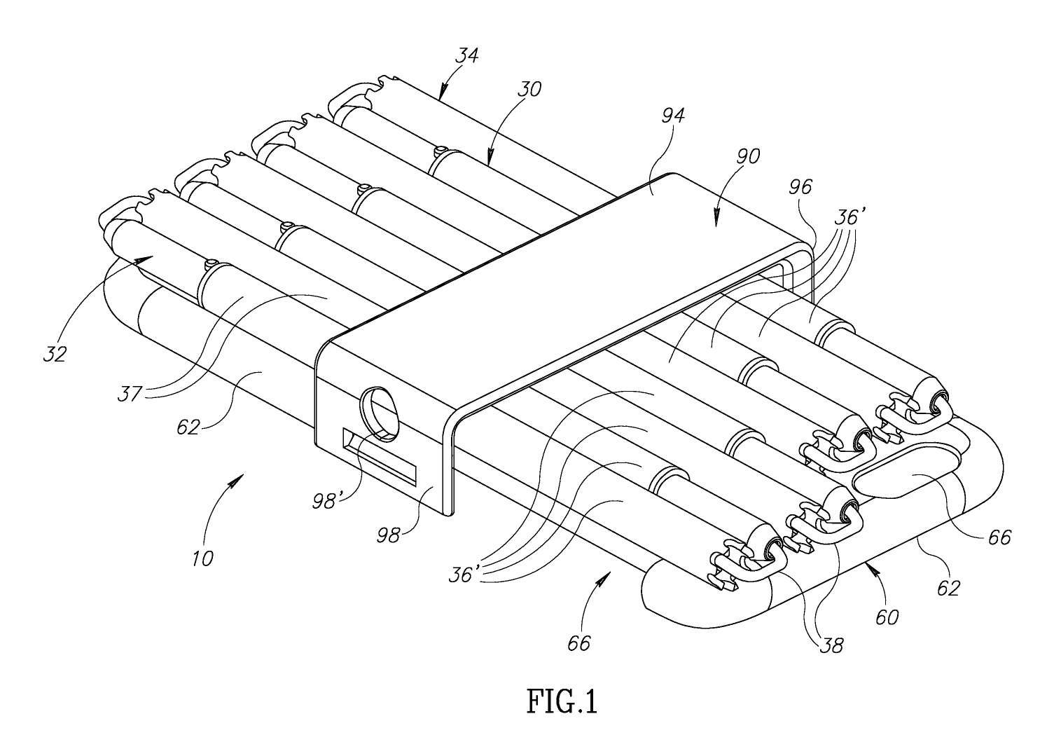

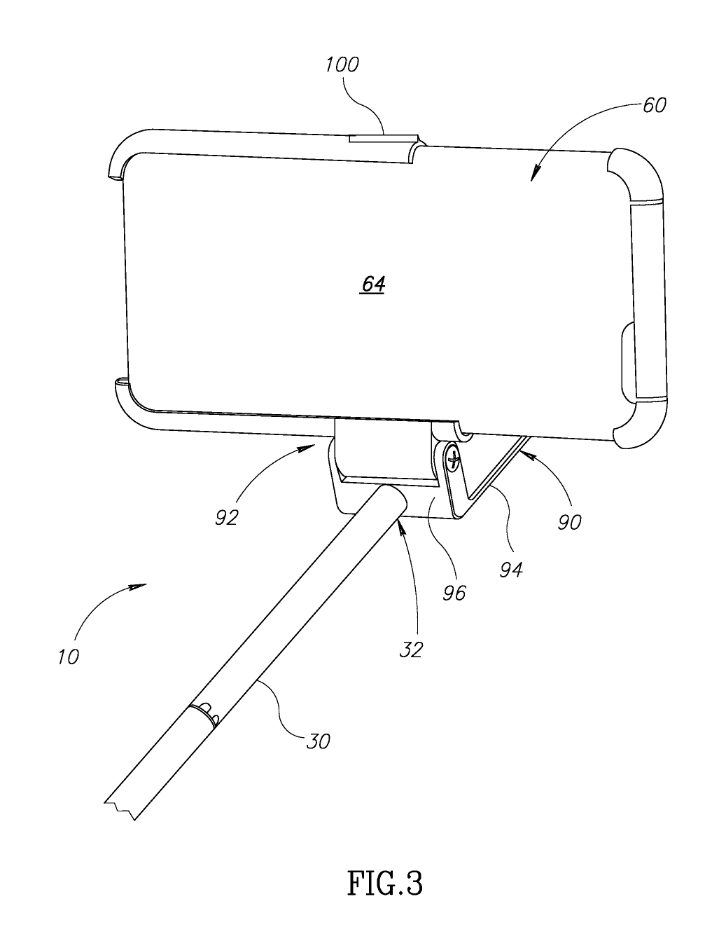

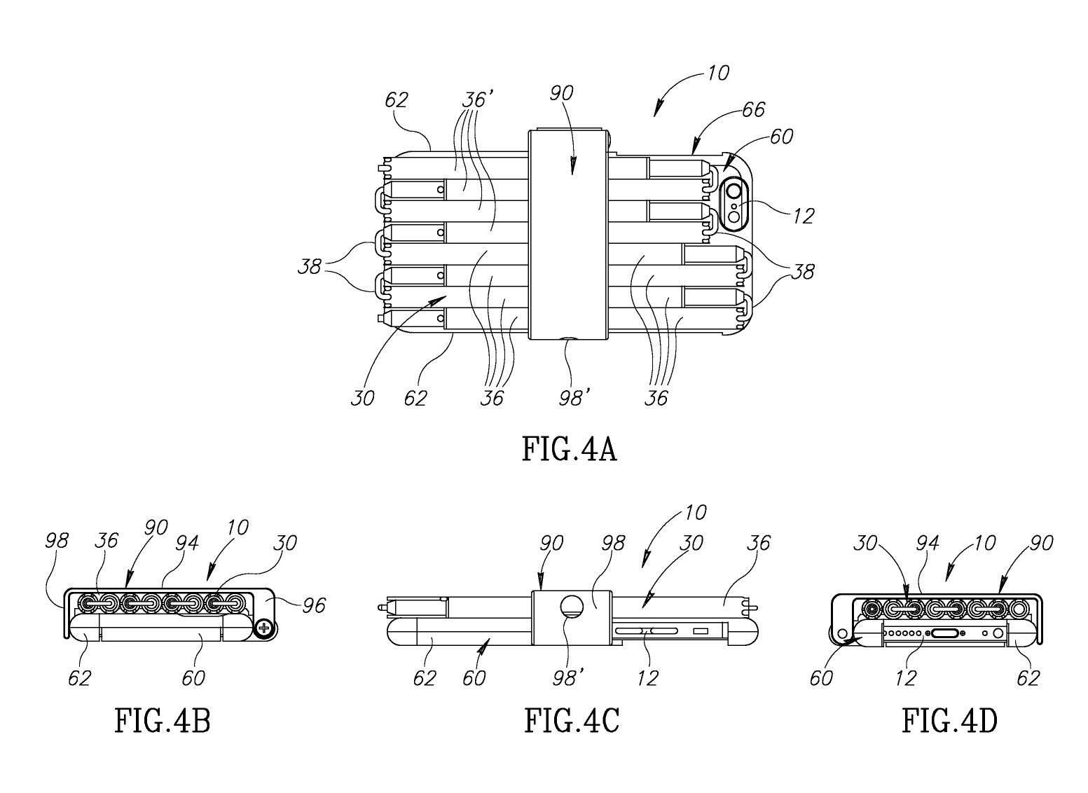

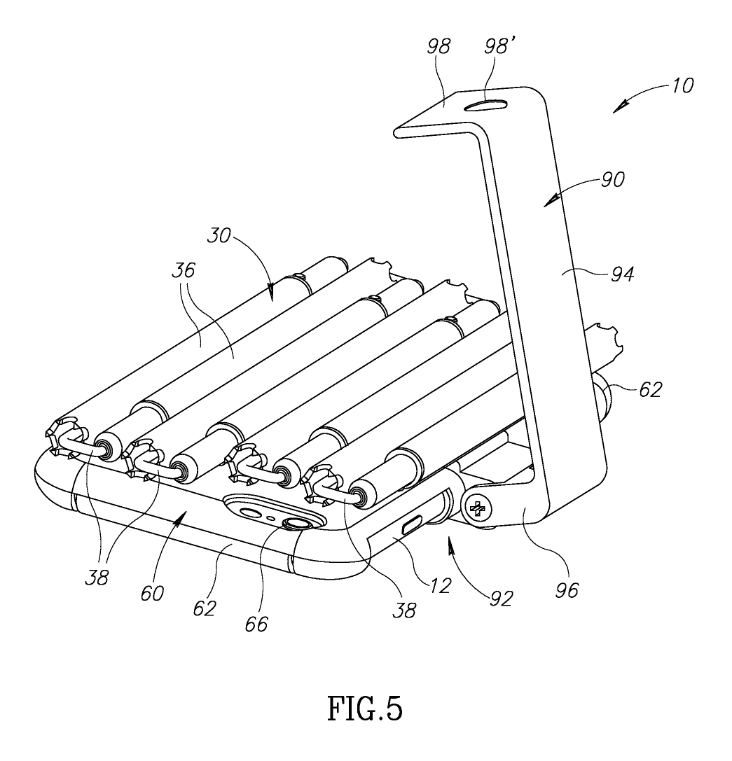

Referring initially to FIG. 1-5, there is described an integral range extender and mechanical protector system 10 for a handheld digital device 12 (FIGS. 4A-5) such as a digital camera and/or video device or an audio recording device. Typically, the digital device combines both of these capabilities as well as transmission capabilities, such as found in a mobile phone, although the use of the present system is not limited thereto.

The system 10 includes a selectably deployable dual purpose collapsible rod, referenced generally 30, and a chassis, referenced generally 60. Preferably, there is also provided a dual purpose engagement member, referenced generally 90, which is operative both to assist in securing rod 30 in position when stored, and also to support device 12 and chassis 60 on rod 30 when extended.

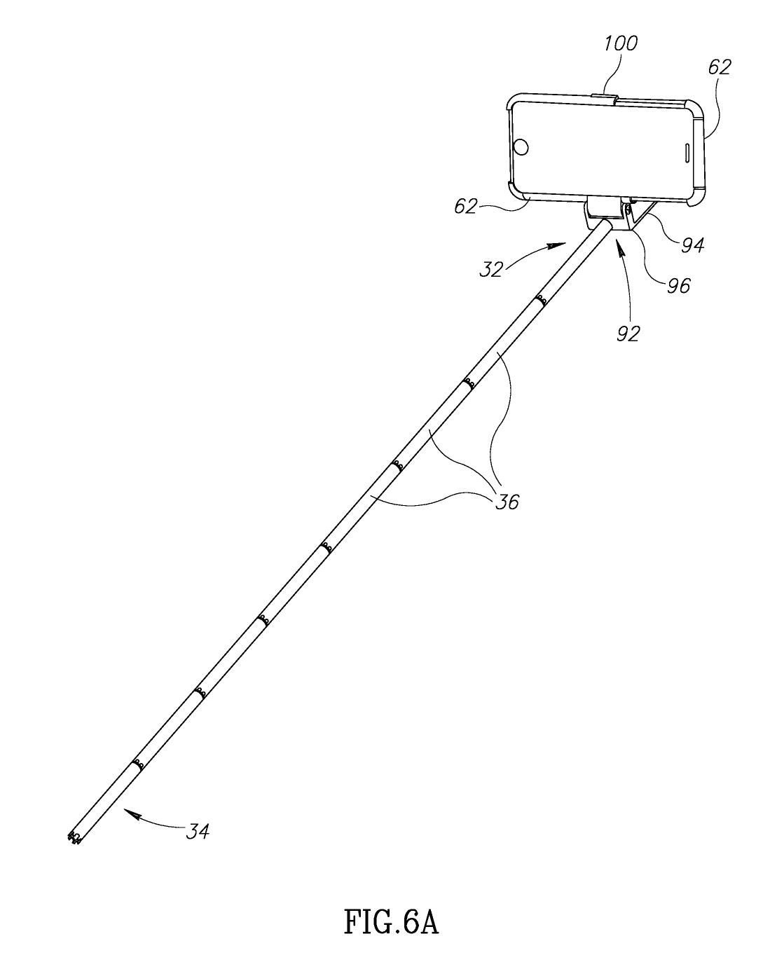

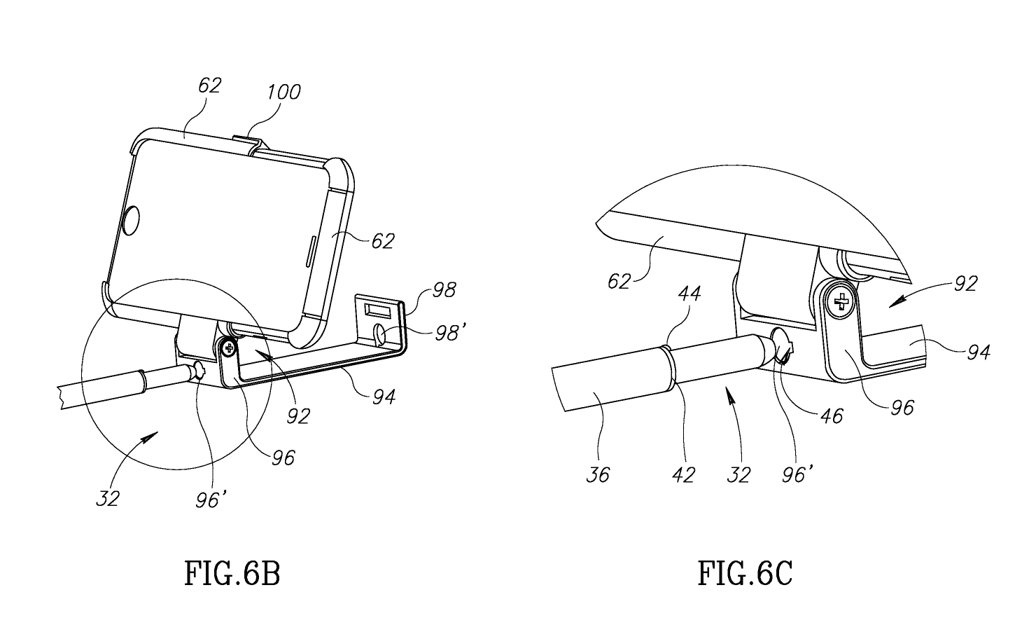

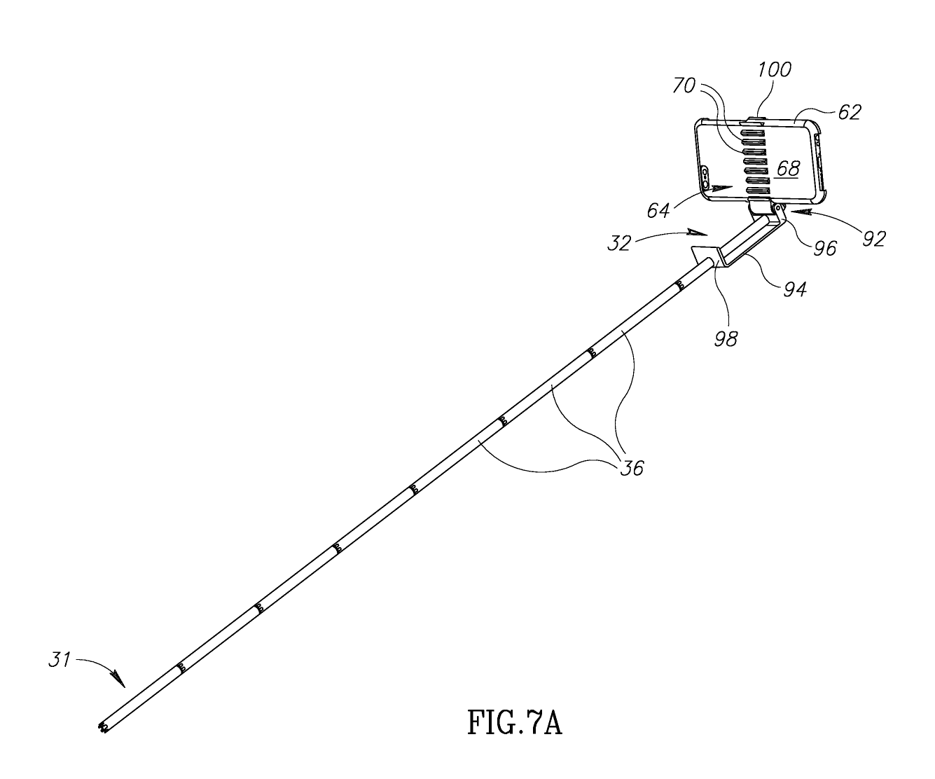

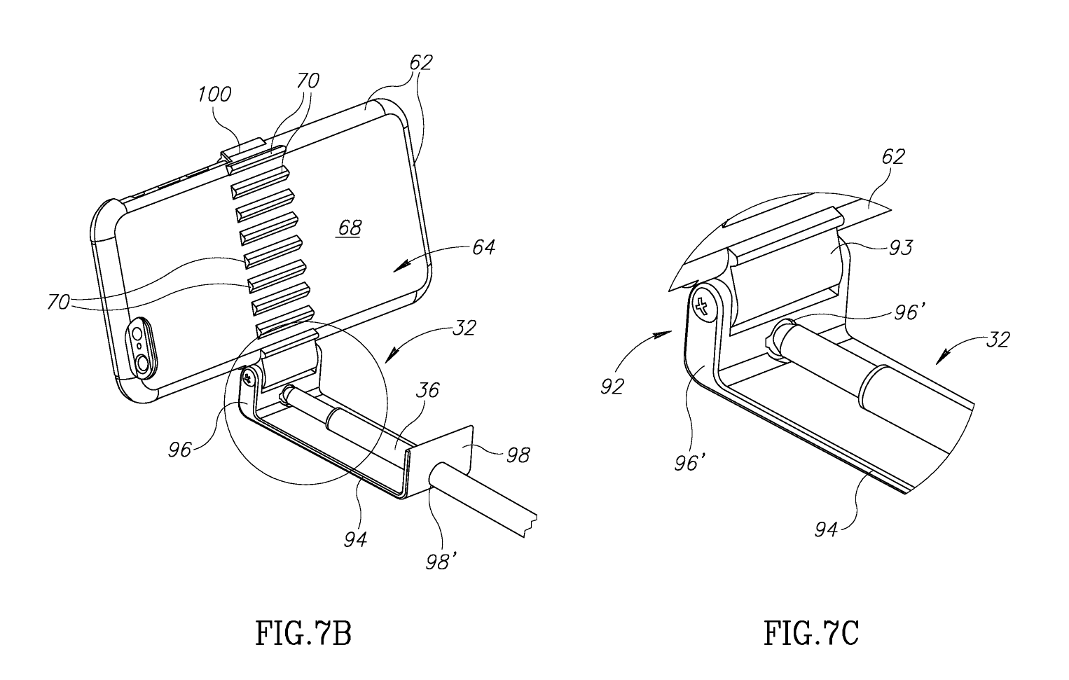

When rod 30 is being used to extend support device 12 remotely from a user (FIGS. 6A-7C), as with so-called “selfie sticks”, the rod 30 connects at a first end 32 to the dual purpose engagement member 90, and is held, typically in the hand of a user, at the second, free end 34 (FIGS. 1, 2, 6A and 7A).

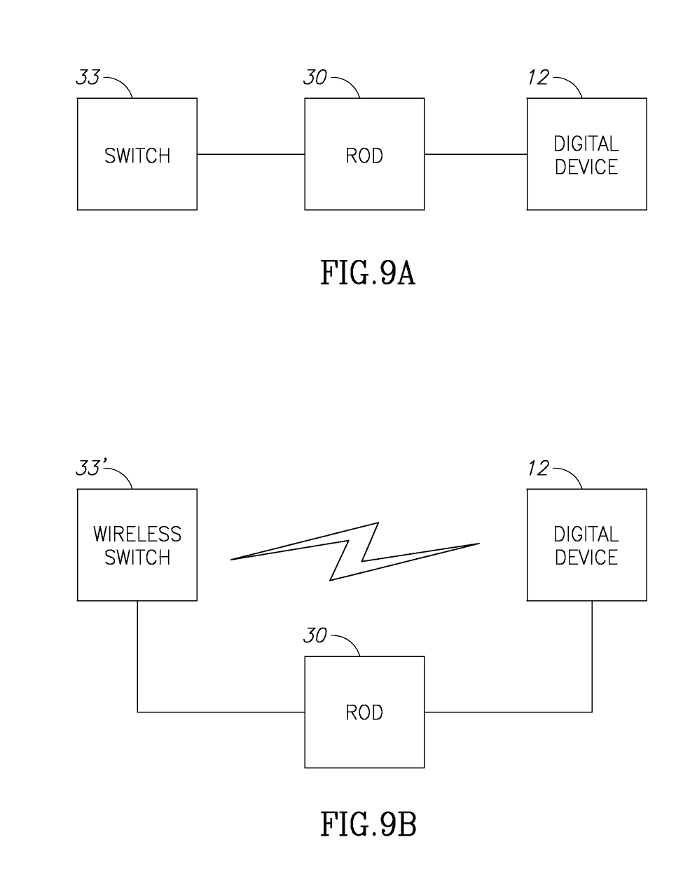

Referring now briefly to FIGS. 9A and 9B, it is seen that when device 12 is supported on second end 34 of the rod 30, remotely from the user, a suitable selector or switch 33 (FIG. 9A), connected to device 12 via a suitable wired connection, or a wireless switch 33′ (FIG. 9B), such as a Bluetooth button or the like, is used to activate device 12. If switch 33 is a wired switch as depicted in FIG. 9A, then it is located on the second end 34 of the rod 30, substantially as known in the art. However, if switch 33′ is a wireless switch as depicted in FIG. 9B, it may be mounted on second end 34 of the rod 30 held by the user or hand-carried separately.

In yet a further embodiment, the Bluetooth switch may be implemented as a Bluetooth function of a mobile device being carried by a pre-authorized additional person in the vicinity of the user.

When not in use, the rod 30 is disconnected from the engagement member 90. It is then collapsed or folded, as described below, and placed in a storage position on the back of the chassis 60 after which it is secured by the dual purpose engagement member 90. As described below, rod 30 is manufactured so as to be strong, while nonetheless taking up minimal space, having a small diameter. Accordingly, as it is stored so as to cover most of the rear panel 64 of chassis 60, it cooperates therewith to provide substantive mechanical protection to device 12.

The rod 30 is formed so as to be small and lightweight so as have minimal bulk, strong so as to enable minimal size and maximum length, and easily deployable. To this end, it is formed preferably of a series of thin diameter elements 36, each preferably no more than 8 mm in diameter. Preferably, they are produced by a 3-D printing process and formed of PLA and/or ABS mixed with a multi-directional carbon fiber. In accordance with a preferred embodiment, when system 10 is manufactured for use in conjunction with a mobile phone such as a Samsung Galaxy 56® or an iPhone 6®, the length of the rod 30 when fully assembled may be 80 cm or more.

A strong elastic cord 38 runs through the interior of the rod elements 36 so as permit compact, folded storage. However, once the engagement member 90 is opened and the rod 30 is released, the presence of the elastic cord imposes a tensile force along the length of the rod 30 so that all of its elements 36, free of any constricting forces, are brought into alignment and axially pulled together by the cord 38 into end-to-end mating connection with each other, such that the rod 30 becomes fully deployed and ready for use, as above.

Mobile phones have various features that must be accessible even when stored in a holder. These may include operating switches, view finders, earphone jacks, power ports and the like. Accordingly, if required, suitable openings 66 are formed in the chassis 60, both on the perimeter edges 62 and on the rear panel 64 so as to enable convenient access to these features when the system 10 is assembled on device 12. Furthermore, as illustrated in the drawings, the rod elements 36 are formed of specific sizes so that when the rod 30 is in storage on the back of the chassis 60, they do not obscure the above features, and allow convenient access thereto. Thus, as seen in FIGS. 1 and 4A, in the present example, rod elements 36′ are shorter than the remaining elements 36.

The chassis 60 is formed such that's its perimeter edges 62 grip and protect the device 12 along its four edges, and such that the rear panel 64 overlies the rear of the device 12 in a manner which is generally similar to known mobile phone holders. Accordingly, other than showing these features clearly in the drawings, they are not specifically described again herein, being well known to one skilled in the art.

However, as seen particularly in FIGS. 7A and 7B, the outward-facing side 68 of rear panel 64 is especially configured so as to engage rod elements 36 when rod 30 is folded down for storage. According to one embodiment, there are provided positioning elements 70, illustrated herein as ridges, operative to receive the rod elements 36 therebetween when the rod 30 is folded, so as to prevent lateral movement relative to the rear panel 64, when stored.

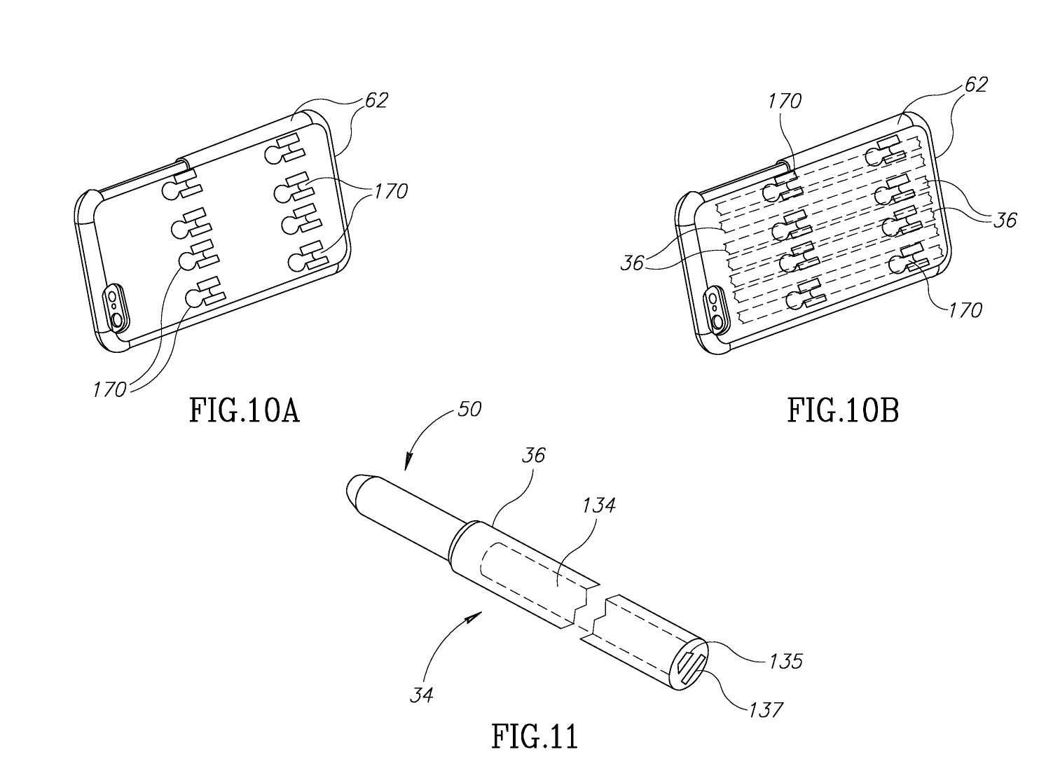

Referring briefly to FIGS. 10A and 10B, there may be provided fastening elements 170 as clips or the like so as to grasp the rod elements 36 therebetween so as to fasten them to the rear side of chassis 60, and not merely position them as in the present embodiment. It will be appreciated that the schematically illustrated clips 170 represent merely one possible way of fastening the rod elements 36 to the rear of the chassis 60, and is intended to include any equivalent manner of doing the same.

Dual purpose engagement member 90 is connected to chassis 60 by a suitable hinge construction 92. In the illustrated embodiment it has a generally elongated U-shaped clasp configuration, having a central portion 94 which is approximately equal to the width of the chassis 60, and first and second end portions, respectively referenced 96 and 98. The engagement member 90 is formed so as to snugly contain the folded rod 30 in storage, against the rear side of the chassis 60.

Each of the shorter end portions 96 and 98 has a specific task. First end portion 96 is not only connected by hinge 92 to a suitable flange portion 93 formed on the side of the chassis 60, but it also has formed therein a first shaped opening 96′. Second end portion 98 is a free end, operative in securing rod 30 against the rear panel 64 of chassis 60, as engagement member 90 is closed about hinge 92 and second end portion 98 is locked against a fastener element 100 formed integrally with chassis 60. As the engagement member 90 and chassis 60 are formed from high strength materials with a certain amount of elasticity, engagement member 90 is opened merely by grasping the free edge of second end portion 98 and flexing out outward and over the fastening element 100. Alternatively, any other suitable method of locking engagement member 90 about rod 30 may be employed.

First shaped opening 96′ is formed so as to engage with a free end portion of the rod 30, and, as illustrated in FIGS. 6A-6C, so as to support the device 12. The free end portion of the rod 30 terminates in a male locking member 40 adapted for insertion through first shaped opening 96′ as seen in FIG. 6C. The radius of male locking member 40 is smaller than that of the remainder of rod element 36, thereby forming a limiting shoulder, seen at 42. As seen, the respective diameters of both the first shaped opening 96′ and male locking member 40 are approximately equal, thereby to permit locking member 40 to pass smoothly through the opening 96′ until limiting shoulder 42 abuts the edge opening 96′.

It is however necessary to prevent rotation of the device 12 about the rod 30, thereby to ensure complete control of the position of device 12 when being held via rod 30. Accordingly, locking member 40 typically has formed thereon a radially oriented locking protrusion 44 immediately adjacent the limiting shoulder 42, adapted for insertion into locking engagement with a corresponding notch 46 formed adjacent to and communicating with shaped opening 96′. It will be appreciated that when protrusion 44 is engaged with notch 46, engagement member 90 and therefore chassis 60 and device 12 are prevented from rotating about rod 30.

In accordance with a preferred embodiment, first end portion 96 of the engagement member 90 supports the device merely by engagement of rod 30 in first shaped opening 96′.

In an alternative embodiment, there may be provided a second shaped opening 98′ in second end portion 98 of engagement member 90, wherein second shaped opening 98′ is coaxially aligned with opening 96′, but has a diameter which is approximately equal to that of rod element 36. When device 12 is mounted onto rod 30 in this manner, as illustrated in FIGS. 7A-7C, rod element 36 passes completely through second opening 98′ so as to extend across the gap between the second and first end portions of engagement member 90 and parallel to central portion 94. As seen, in this embodiment, male locking member 40 is also inserted through and locked with first shaped opening 96′ in a manner similar to that shown and described above in conjunction with FIGS. 6A-6C, but from the interior of the clasp shaped engagement member 90. In this manner, rod 30 is operative to support chassis 60 and thus device 12 at two points, thus providing even greater stability, and thus also enabling the first engagement portion 96 to be made somewhat less thick.

As discussed above, it is desirable that when a user is holding a device 12 by use of rod 30, no rotation should occur between device 12 and the rod. Accordingly, this then requires that once the rod elements 36 are assembled, they too are locked in a position whereat no relative rotation with respect to their longitudinal axis is permitted.

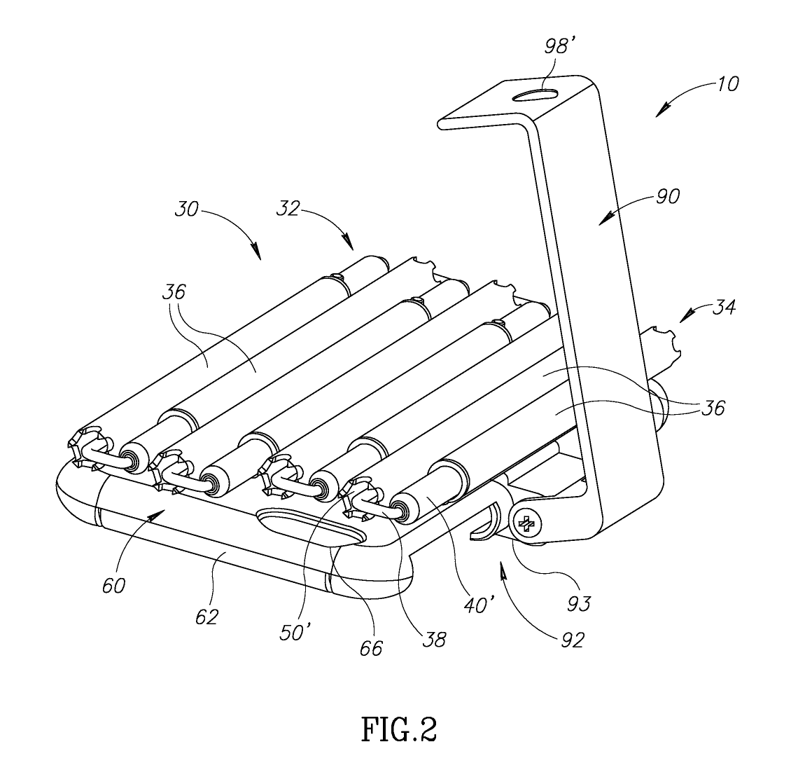

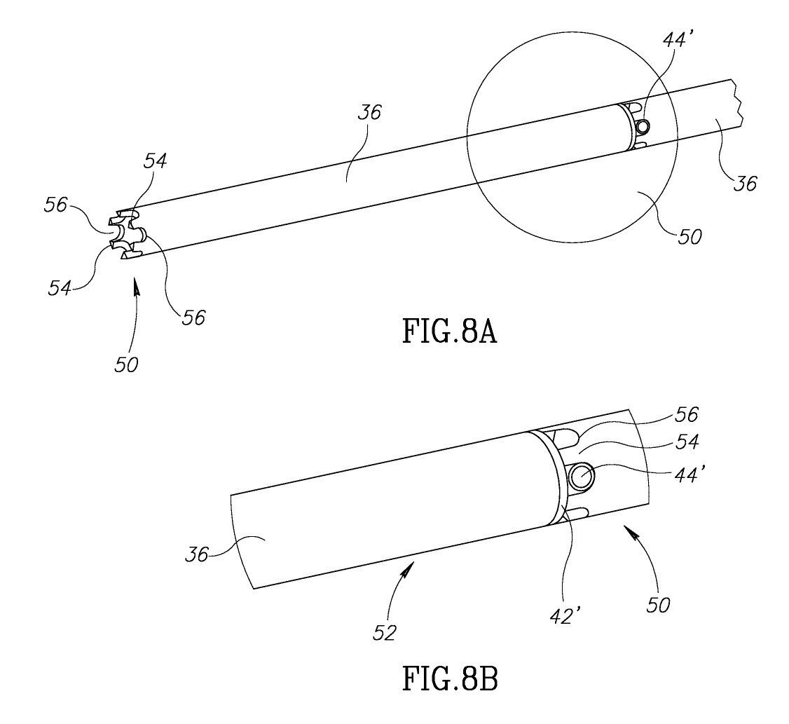

Referring now to FIGS. 2, 8A and 8B, in order to prevent such undesired rotation from occurring, rod elements 36 are formed so as to interlock once they are engaged with each other. Each rod element 36, in the present embodiment, is provided with different first and second ends, respectively referenced 50 and 52.

First end 50 has formed thereat a series of crenations, or an alternating sequence of teeth 54 and notches 56. The second end 52 of each rod element 36 is provided with a male locking member 40′ (FIG. 2) which is similar to male locking member 40, shown and described above in conjunction with FIG. 6C. Accordingly, locking member 40′ is smaller than that of the remainder of rod element 36, thereby forming a limiting shoulder, seen at 42′. The respective diameters of both the end opening 50′ (best seen in FIG. 2) of first end 50 and male locking member 40′ (FIG. 2) are approximately equal, thereby to permit locking member 40′ to pass smoothly through the opening 50′ until limiting shoulder 42′ abuts teeth 54.

In order to prevent relative rotation between the two mutually engaged rod elements 36, however, locking member 40′ typically also has formed thereon a radially oriented locking protrusion 44′ immediately adjacent the limiting shoulder 42′, adapted for insertion into locking engagement with any of the notches 56. As described above, when the rod 30 is released for deployment, adjacent rod elements 36 are straightened under the force of the elastic cord 38, and the adjacent first and second ends 50 and 52 of each pair of adjoining rod elements 36 are pulled together under the force of the cord 38. Therefore, all that is required so as to obtain full, non-rotational engagement of two adjoining rod elements 36, is that locking protrusion 44′ of male locking member 40′ engages any one of the notches 56 of the facing first end 50.

As described hereinabove, rod elements 36 are hollow, thereby being lightweight, and being suitable for a male-female interlocking mating when rod 30 is assembled and fully deployed. However, in accordance with one embodiment, and referring now to FIG. 11, the rod element 36 which functions as a handle when rod 30 is deployed, may serve to house a rechargeable backup battery 134, suitably configured so as to fit within the hollow interior of the rod element 36. Operating generally as known for such backup batteries, the exposed end of battery 134 typically has a micro-USB port 135 so as to facilitate charging thereof, and a USB port 137 for charging an electrical device such as digital device 12.

It will be appreciated by persons skilled in the art that the present invention is not limited by what has been shown and described hereinabove, merely by way of non-limiting example. Rather, the scope of the invention is defined solely by the claims, which follow.

We claim:

1. An integral range extender and mechanical protector system for a handheld digital device, the system including:
a chassis adapted for securing to the device; and
a selectably deployable dual purpose collapsible rod operable in a first, folded mode for storage across the rear of the device so as to cover a major portion of the area thereof thereby, together with said chassis, to absorb mechanical forces directed towards the sides or rear of the device, and further operable in a second mode for extension in a direction transverse from the chassis, whereby a first end is adapted to support the device and a second distal end is adapted to be held in the hand of a user, wherein, in said second mode, use of said collapsible rod permits positioning of the device from the user and use thereof remotely from the user.

2. A system according to claim 1, also including a dual purpose engagement member operative for engagement with said chassis so as to secure said collapsible rod thereto when in said first, folded mode and for supporting said chassis and device on said collapsible rod when in said second mode.

3. A system according to claim 2, wherein said first end of said collapsible rod and said dual purpose engagement element are configured for interlocking engagement so as to prevent relative rotation therebetween, thus also preventing rotation of the device about said collapsible rod when supported thereon.

4. A system according to claim 3, wherein said first end of said collapsible rod terminates in a male locking member and said dual purposed engagement member has a shaped opening formed therein adapted to receive said male locking member,
and wherein said male locking member has formed thereon a locking protrusion and said dual purpose engagement member has formed therein a notch communicating with said shaped opening, said notch being adapted to receive said locking protrusion therein in locking engagement, thereby to prevent relative rotation between said male locking member and said shaped opening.

5. A system according to claim 1, wherein said collapsible rod is formed of a plurality of self-assembly, mutually foldable rod elements configured for end-to-end assembly.

6. A system according to claim 5, wherein said collapsible rod also includes an elastic cord element extending through said plurality of self-assembly rod elements, operative, in the absence of forces preventing this, to coaxially align said rod elements and pull them together from a mutually folded arrangement into end-to-end mating connection.

7. A system according to claim 5, wherein each said rod element has a first and second end, each said first end being adapted for end-to-end engagement with said second end of an adjacent rod element, wherein said first and second ends of each said rod element are configured for interlocking engagement so as to prevent relative rotation therebetween, thus also preventing rotation of the device about any portion of said collapsible rod when supported thereon.

8. A system according to claim 7, wherein said first end of each said rod element terminates in an alternating sequence of teeth and notches surrounding an opening, and said second end of each said rod element includes a male locking member having a limiting shoulder formed at a predetermined distance from the tip of said male member, said male member of a first rod element being adapted for insertion through said opening of a second rod element so as to become mutually engaged therewith, until a maximum depth whereat said limiting shoulder abuts said teeth,
wherein said male locking member has formed thereon a locking protrusion which, when said male member is at said maximum depth, said locking protrusion is engaged by any one of said notches, thereby to prevent relative rotation between said first and second rod elements.

9. A system according to claim 5, wherein said plurality of rod elements are produced by a 3-D printing process, and formed of PLA and/or ABS mixed with a multi-directional carbon fiber.

10. A system according to claim 9, also including a remotely located control for operating the digital device.

11. A system according to claim 10, wherein said remotely located control is mounted at the second, distal end of said collapsible rod.

12. A system according to claim 1, wherein said chassis has a rear side having provided thereon positioning elements for positioning said collapsible rod against said rear side when in said first, folded mode.

13. A system according to claim 1, wherein said chassis has a rear side having provided thereon fastening elements for grasping and fastening said rod elements against said rear side when in said first, folded mode.

14. A system according to claim 1, wherein at least said second end portion of said collapsible rod is hollow, said system further including a backup battery housed within said hollow second end portion of said collapsible rod.
